(19) United States
(12) Patent Application Publication
(10) Pub. No.: US 2017/0040871 A1
(43) Pub. Date: Feb. 9, 2017

(54) ELECTRICITY GENERATION DEVICE AND METHOD

(71) Applicant: ALFA POWER CO., LTD., New Taipei City (TW)

(72) Inventors: JUNG-CHAI HSIEH, New Taipei City (TW); MIN-CHING HSIEH, New Taipei City (TW)

(21) Appl. No.: 14/817,221

(22) Filed: Aug. 4, 2015

(51) Int. Cl. H02K 7/18

(52) U.S. Cl. CPC H02K 7/1853; H02K 53/00

(57) ABSTRACT

The present invention teaches an environmentally friendly and convenient way of electricity generation. The electricity generation device contains a rotational arm, a weight, and a moving mechanism. The rotational arm is rotatably joined to an electricity generation mechanism and configured with a track element along its length. The weight is movably configured in the track element. The moving mechanism applies a first moving force to move the weight from a first end side of the rotational arm along the track element's length to a second end side opposite to the first end side. A torque is thereby produced to turn the rotational arm and electricity is generated from the electricity generation mechanism.

### BACKGROUND OF THE INVENTION

(a) Technical Field of the Invention

The present invention is generally related to electricity generation, and more particular to an electricity generation device and a related method employing a rotational arm.

(b) Description of the Prior Art

Electricity is required power for daily life and it is also the driving force for economic growth. Conventional and emerging high-tech industries all require electricity Most of thermal, nuclear, wind, or hydraulic power generation involve rotational mechanical energy driving a generator to produce electricity

The waste from thermal power generation is considered a major source of global warming. Nuclear energy is dangerous. Wind and hydraulic power generation suffers seasonal variations. Solar power generation requires sufficient sunshine and as such is subject to location limitation. As the consumption of electricity continuously increases, finding better electricity generation device and method is an important research issue.

### SUMMARY OF THE INVENTION

An objective of the present invention is to provide an electricity generation device which contains a rotational arm, a weight, and a moving mechanism. The rotational arm is rotatably joined to an electricity generation mechanism and configured with a track element along its length. The weight is movably configured in the track element. The moving mechanism applies a first moving force to move the weight from a first end side of the rotational arm along the track element's length to a second end side opposite to the first end side. A torque is thereby produced to turn the rotational arm and electricity is generated from the electricity generation mechanism.

Preferably, there are a number of rotational arms, and each rotational arm is configured with a separate weight and a separate moving mechanism.

Preferably, the rotational arms are arranged so that each pair of the rotational arms is separated by an identical angle.

Preferably, the rotational arms are arranged diametrically and in parallel.

Preferably, the rotational arms are configured on a frame.

Preferably, the frame is cylindrical, and the electricity generation mechanism is coupled to an axle of the cylindrical frame.

Preferably, the moving mechanism contains a DC motor engaging the track element so as to move the track element along the rotational arm's length.

Preferably, the electricity generation device further contains an armature. At least an end of the rotational arm is configured with an electrical contact electrically connected to the DC motor. The electrical contact electrically contacts the armature as the rotational arm spins and passes through the armature.

Another objective of the present invention is to provide an electricity generation method containing the following steps. In a first step, a first moving force is applied on a weight when the weight is at a first end side of a rotational arm to move the weight along the rotational arm's length towards a second end side of the rotational arm opposite to the first end side. In a second step, the rotational arm is turned by a torque produced by the weight on the rotational arm so as to generate electricity. An electricity generation mechanism is coupled to the rotational arm.

Preferably, the first moving force is one of an electromechanical force, an elastic restoration force, a magnetic force, and a combination of the above.

The present invention applies a first moving force to move a weight from a first end side of a rotational arm to a second end side, and the rotational arm is turned by a torque from the weight to produce electricity. Then, through repeatedly turning the rotational arm, electricity is produced continuously. The present invention does not produce waste with little energy consumption, does not suffer from weather or seasonal changes, and has no location limitation. Compared to the prior art, the present invention is environmentally friendlier and more convenient.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a front-view diagram showing an electricity generation device according to a first embodiment of the present invention.

FIG. 2 is a top-view diagram showing the electricity generation device of FIG. 1.

FIG. 3 is another front-view diagram showing the electricity generation device of FIG. 1.

FIGS. 4A to 4D show operation scenarios of the electricity generation device of FIG. 1.

FIG. 5A is a front-view diagram showing an electricity generation device according to a second embodiment of the present invention.

FIG. 5B is a schematic diagram showing the electricity generation device of FIG. 5A.

FIG. 5C is a front-view diagram showing an electricity generation device according to a third embodiment of the present invention.

FIG. 5D is a top-view diagram showing an electricity generation device where an electrical contact at an end of a rotational arm is employed.

FIG. 5E is a front-view diagram showing a scenario of an electricity generation device where two electrical contacts at both ends of a rotational arm is employed.

FIG. 5F is a front-view diagram showing another scenario of the electricity generation device of FIG. 5D.

FIG. 5G is a schematic diagram showing the electricity generation device of FIG. 5E.

FIG. 5H is a top-view diagram showing the electricity generation device of FIG. 5A.

FIG. 6A is a top-view diagram showing an electricity generation device according to a fourth embodiment of the present invention.

FIG. 6B is a top-view diagram showing an electricity generation device according to a fifth embodiment of the present invention.

FIG. 7 is a front-view diagram showing an electricity generation device according to a sixth embodiment of the present invention.

FIG. 8 is a front-view diagram showing an electricity generation device according to a seventh embodiment of the present invention.

FIG. 9A is a perspective diagram showing an electricity generation device according to an eighth embodiment of the present invention.

FIG. 9B is a front-view diagram showing the electricity generation device of FIG. 9A.

FIG. 9C is a top-view diagram showing the electricity generation device of FIG. 9A.

FIG. 10 is a flow diagram showing the steps of an electricity generation method according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

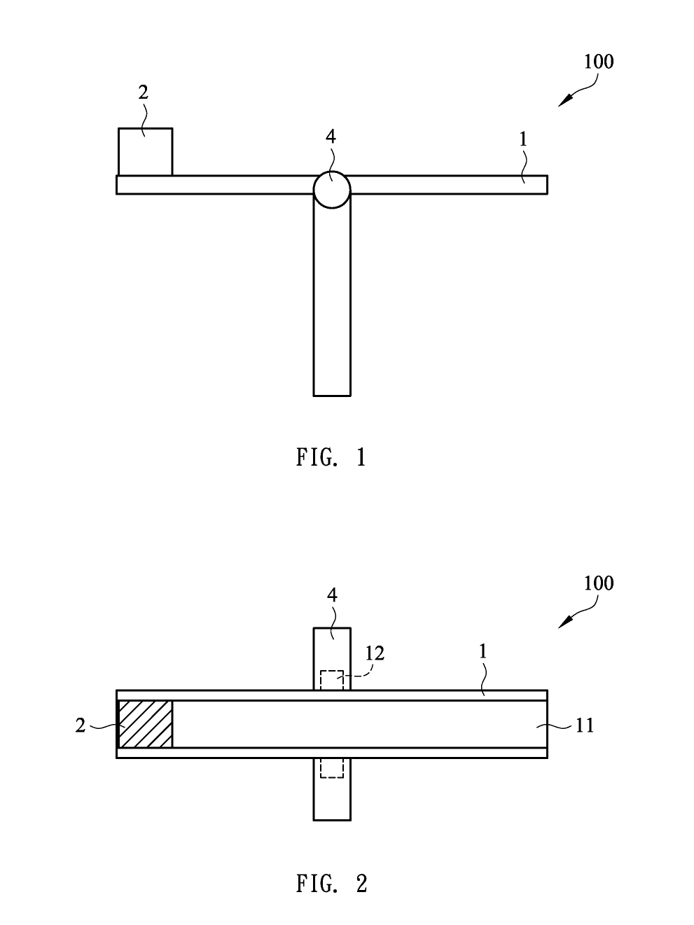

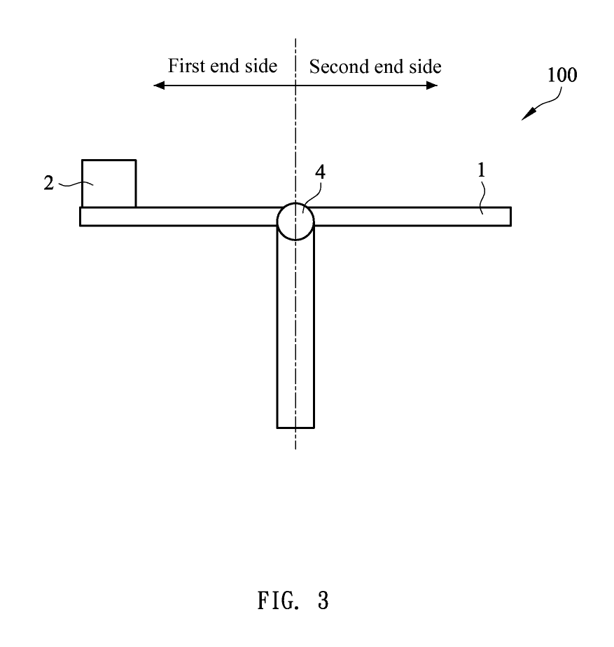

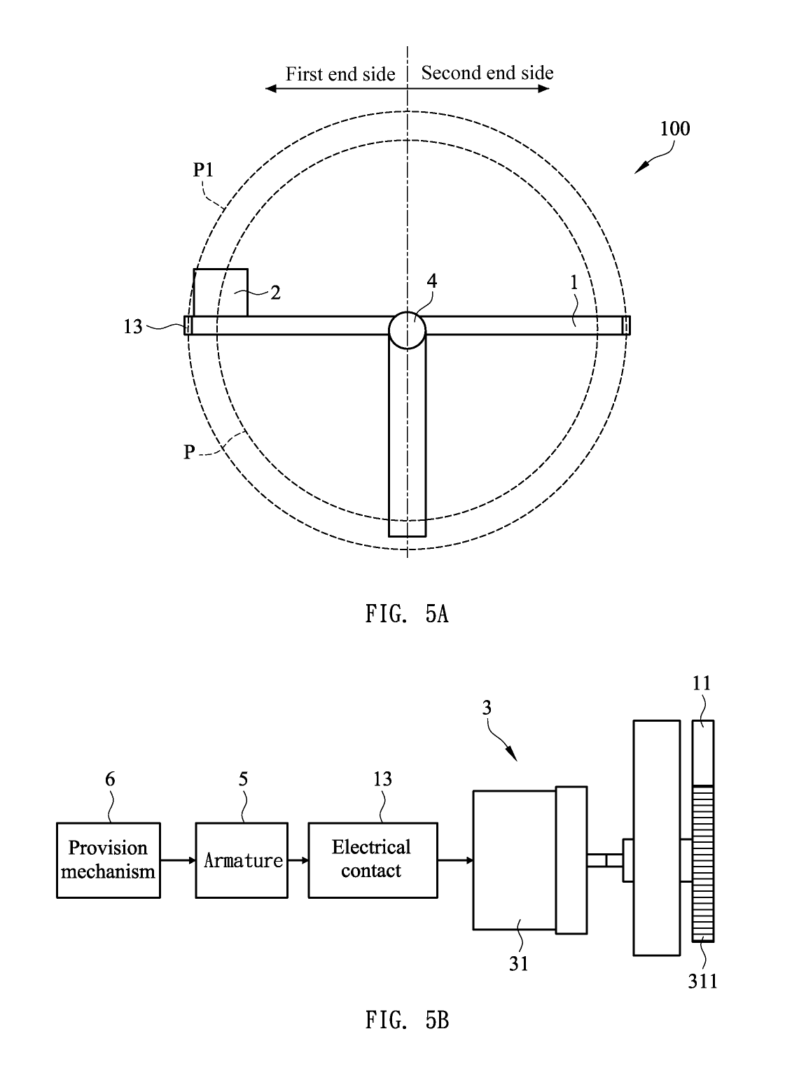

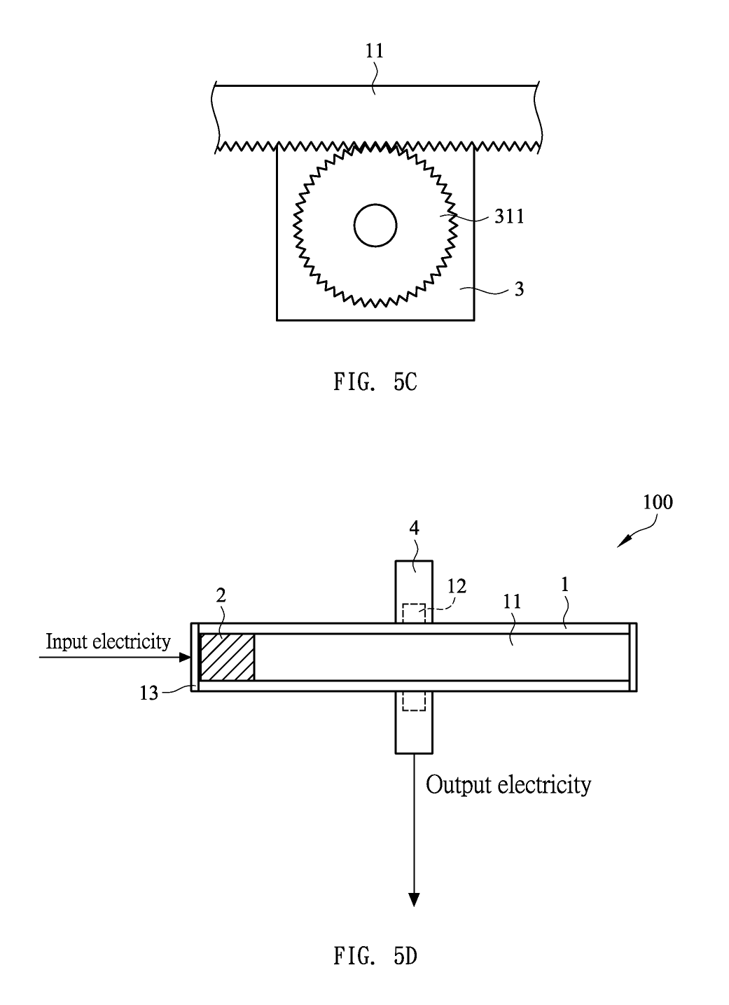

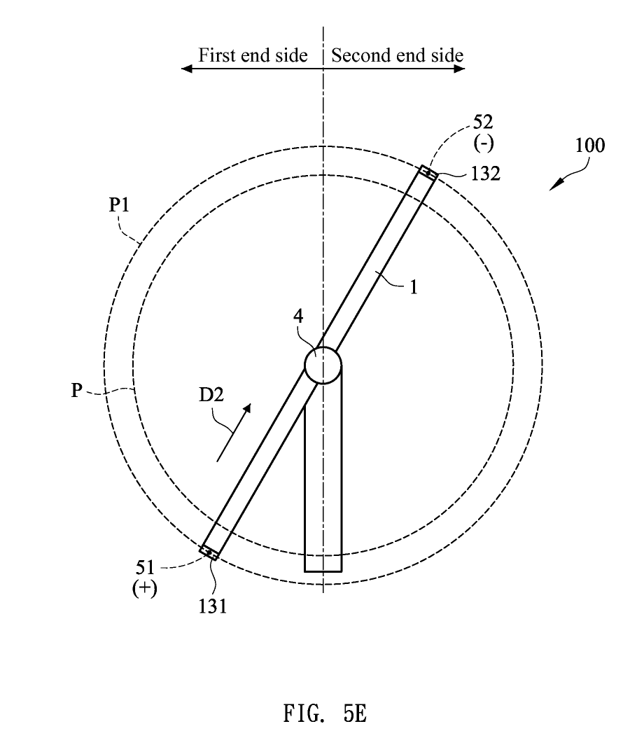

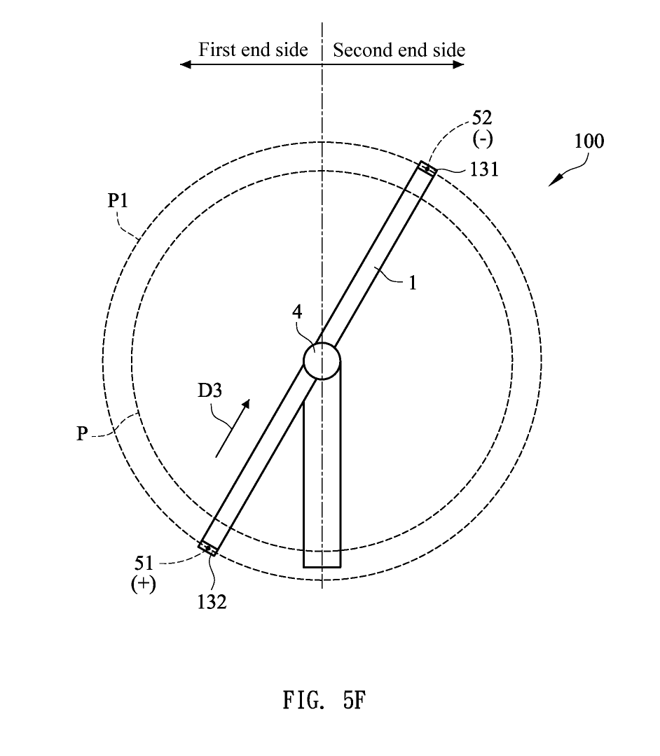

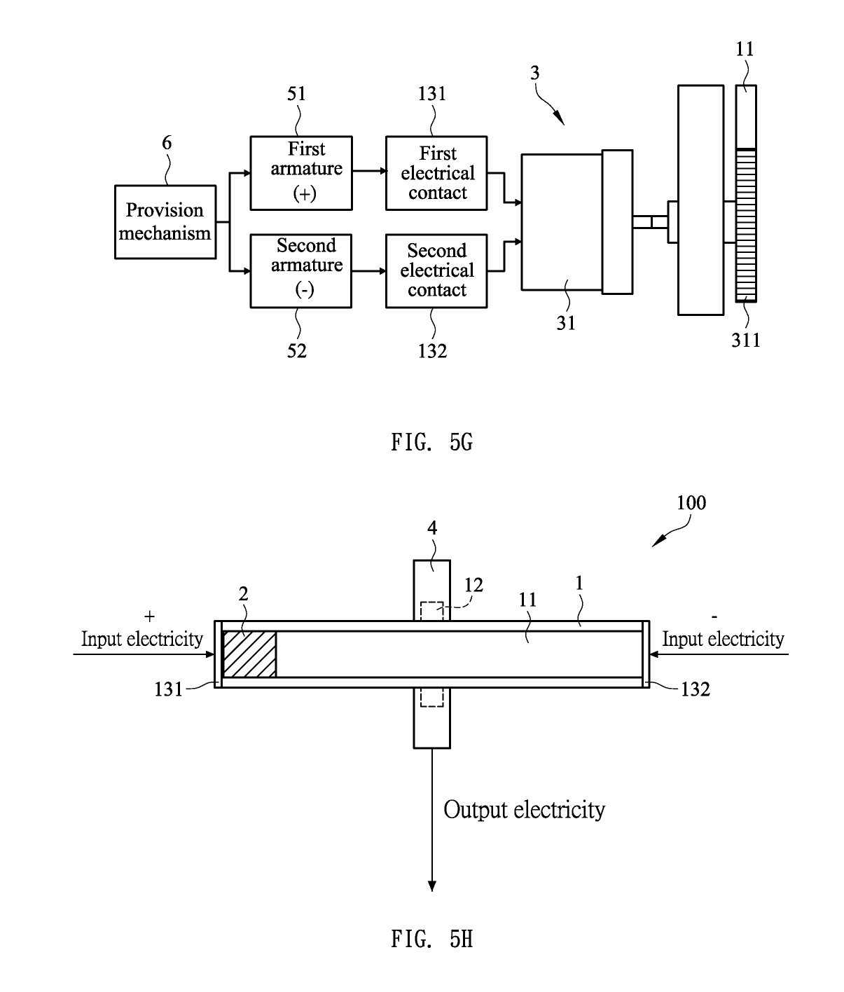

As shown in FIGS. 1 to 3, an electricity generation device 100 according to a first embodiment of the present invention contains a rotational arm 1, a weight 2, and a moving mechanism 3 (as shown in FIGS. 5B and 5C). The rotational arm 1 is rotatably joined to an electricity generation mechanism 4, and is configured with an indented track element 11 along its length. The weight 2 is movably configured in the track element 11. In the present embodiment, the rotational arm 1 is pin-joined to an axle 12 of the electricity generation mechanism 4's armature (not shown). As the armature is driven by the rotational arm 1 to revolve, electricity is induced from the electricity generation mechanism 4.

The moving mechanism 3 applies a first moving force to move the weight 2 from a first end side of the rotational arm 1 along the track element 11 to a second end side opposite to the first end side. A torque is thereby produced to turn the rotational arm 1 so as to generate electricity from the electricity generation mechanism 4.

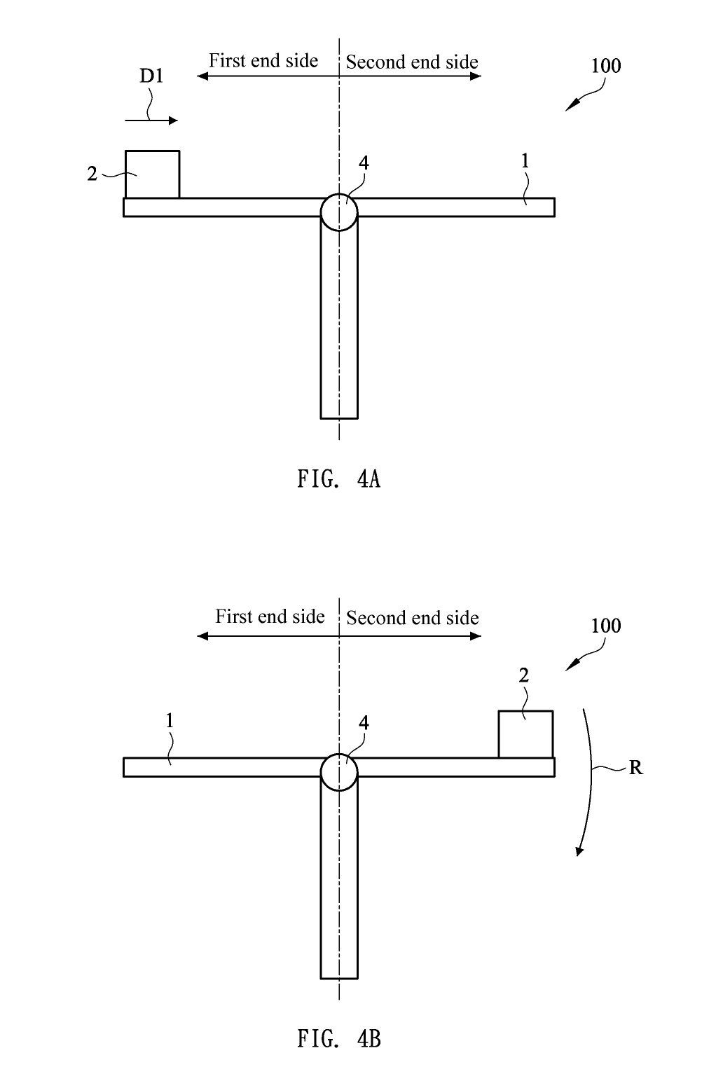

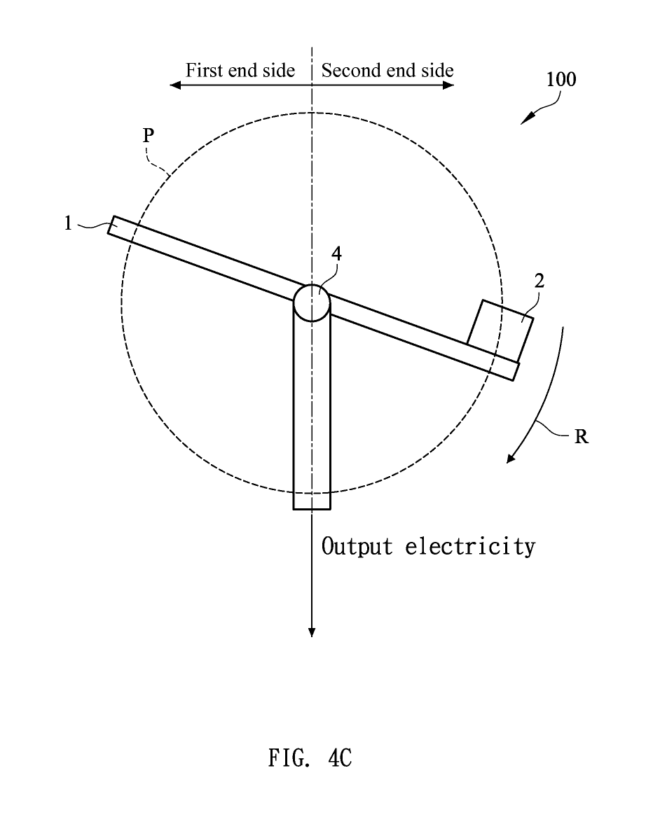

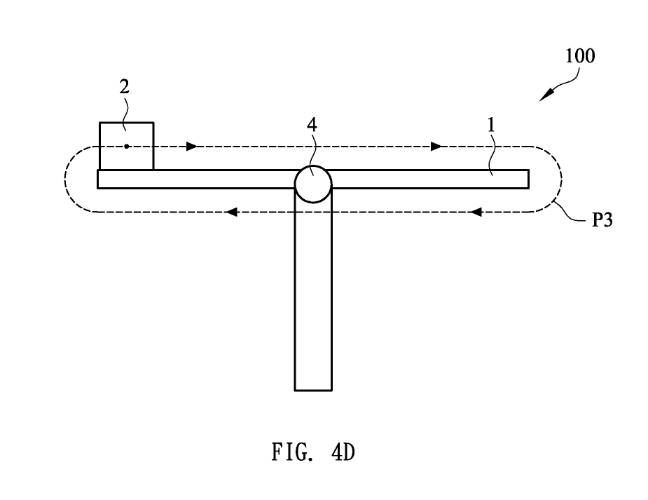

As shown in FIGS. 4A to 4C, along with FIG. 10, a method of electricity generation according to an embodiment of the present invention contains the following steps. In step S1, a first moving force is applied on a weight 2 when the weight 2 is at a first end side of the rotational arm 1 to move the weight 2 along a direction D1 towards a second end side of the rotational arm 1 opposite to the first end side. In step S2, the rotational arm 1 is turned by a torque produced by the weight 2 on the rotational arm 1 to generate electricity where an electricity generation mechanism 4 is coupled to the rotational arm 1.

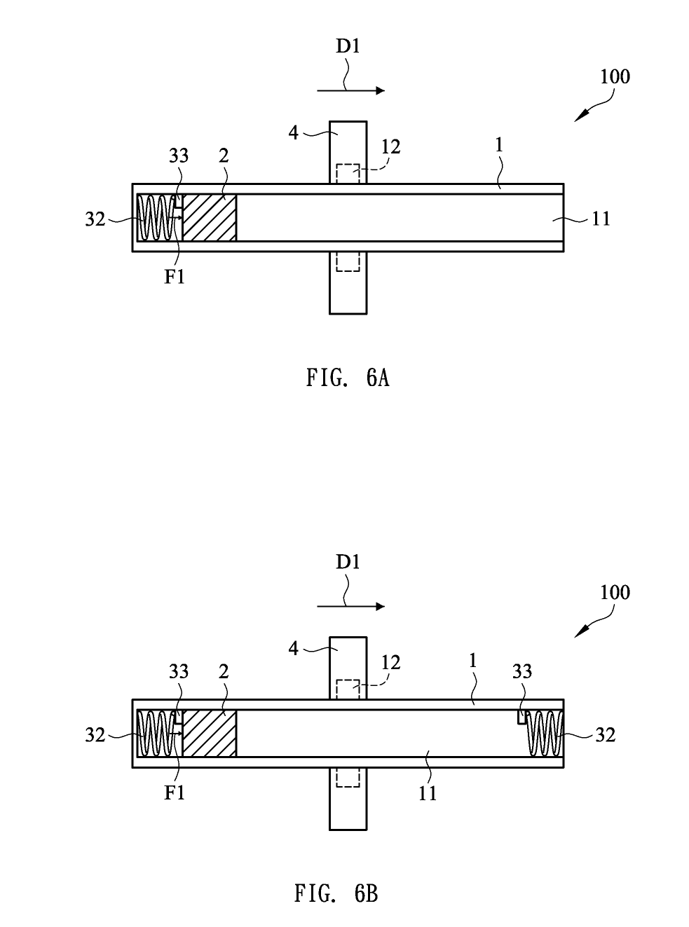

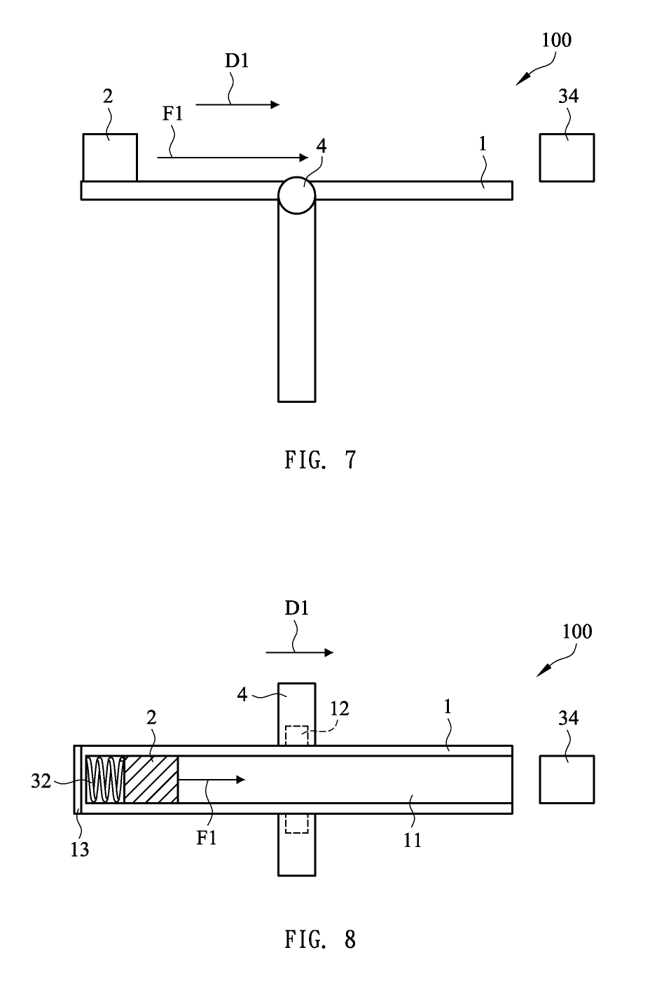

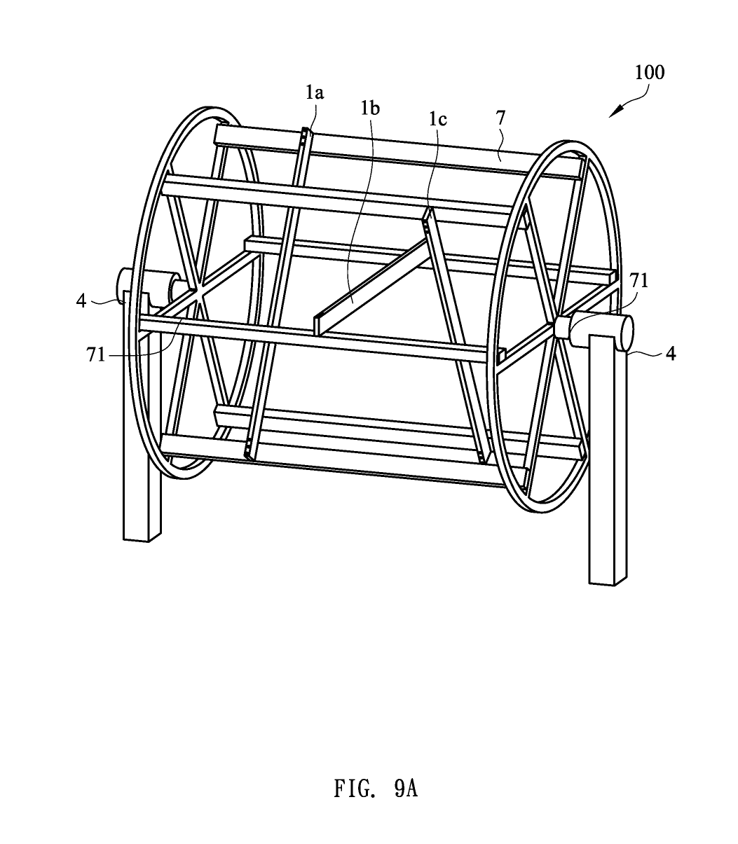

As shown in FIG. 4A, the first moving force is applied on the weight 2 at the first end side of the rotational arm 1 to move the weight 2 along the direction D1 towards the second end side of the rotational arm 1. The moving force from the moving mechanism 3 can be an electromechanical force (as shown in FIGS. 5A to 5D), a restoration force from an elastic element (as shown in FIG. 6A), a magnetic force (as shown in FIG. 7), or a combination of the above (as shown in FIG. 8).

As shown in FIGS. 5A to 5D, when the moving force is an electromechanical force, the moving mechanism 3 contains a DC motor 31 engaging the track element 11 through a gear 311. In the present embodiment, the track element 11 has linearly arranged teeth coupled with the gear 311. Alternatively, the track element 11 is a chain or a belt coupled with the gear 311. As the track element 11 is driven by the gear 311, the weight 2 is moved along the length of the rotational arm 1. In order to provide electricity to the DC motor 31, an end of the rotational arm 1 is configured with an electrical contact 13. The electricity generation device 100 also contains an armature 5 electrically connected to a provision mechanism 6. The electrical contact 13 electrically contacts the armature 5 as the rotational arm 1 spins and passes through the armature 5. The electricity from the provision mechanism 6 is then conducted to the DC motor 31 so that the track element 11 moves along the length of rotational arm 1 and carries the weight 2. The present invention is not limited to the above embodiment. For example, the DC motor 31 can also be powered by a battery, or by the electricity generation mechanism 4. In the present embodiment, the armature 5 is preferably configured at a location on a rotational path P1 of the electrical contact 13. As such, as the electrical contact 13 revolves, it passes through the location and contacts the armature 5 at fixed intervals. The conduction of electricity from the provision mechanism 6 to the DC motor 31 is also at fixed intervals. Therefore, each time the weight 2 is moved to the second end side of the rotational arm 1 to produce the torque is at fixed intervals as well.

As shown in FIGS. 5E to 5H, both ends of the rotational arm 1 are configured with a first electrical contact 131 and a second electrical contact 132, respectively. A first armature 51 (positive) and a second armature 52 (negative) are configured on the rotational path P1 of the first and second electrical contacts 131 and 132. As the first electrical contact 131 electrically contacts the first armature 51 (positive) and the second electrical contact 132 electrically contacts the second armature 52 (negative), the gear 311 driven by the DC motor 31 turns in a first direction and engages the track element 11 to move the weight 2 along a direction D2 (from the first electrical contact 131 towards the second electrical contact 132). When the first electrical contact 131 electrically contacts the second armature 52 (negative) and the second electrical contact 132 electrically contacts the first armature 51 (positive), the gear 311 driven by the DC motor 31 turns in a second direction and engages the track element 11 to move the weight 2 along a direction D3 (from the second electrical contact 132 towards the first electrical contact 131).

As shown in FIG. 6A, when the moving force is a restoration force from an elastic element, the moving mechanism 3 contains an elastic element 32 such as a spring configured at the first end side of the rotational arm 1. When a blocking element 33 is removed, the compressed elastic element 32 applies a first moving force F1 onto the weight 2 so that the weight 2 moves from the first end side towards the second end side of the rotational arm 1 along the direction D1. In an alternative embodiment shown in FIG. 6B, the elastic element 32 can be configured at the second end side of the rotational arm 1 so as to move the weight 2 from the second end side towards the first end side of the rotational arm 1 opposite to the direction D1.

As shown in FIG. 7, the first moving force F1 can also be a magnetic force, and the moving mechanism 3 contains a magnetic element 34 such as a magnet whereas the weight 2 is a metallic object or a magnetic object, attracting the weight 2 to move from the first end side towards the second end side of the rotational arm 1 along the direction D1.

Then, as shown in FIG. 4B, the weight 2 moved to the second end side of the rotational arm 1 applies a torque on the rotational arm 1 so that it spins along a direction R.

As shown in FIG. 4C, when the rotational arm 1 turns along the direction R, the armature of the electricity generation mechanism 4 turns as well so as to produce electricity. Due to the inertial effect of the rotation, the weight 2 will return back to the first end side of the rotational arm as it follows the rotational path P. Then another round of electricity generation by the steps S1 and S2 shown in FIG. 10 can be repeated. As such, the electricity generation mechanism 4 can produce electricity continuously. As shown in FIG. 4D, in additional to the directions D1 and D2, the weight 2 can also follow a cyclic moving path P3 around the rotational arm 1.

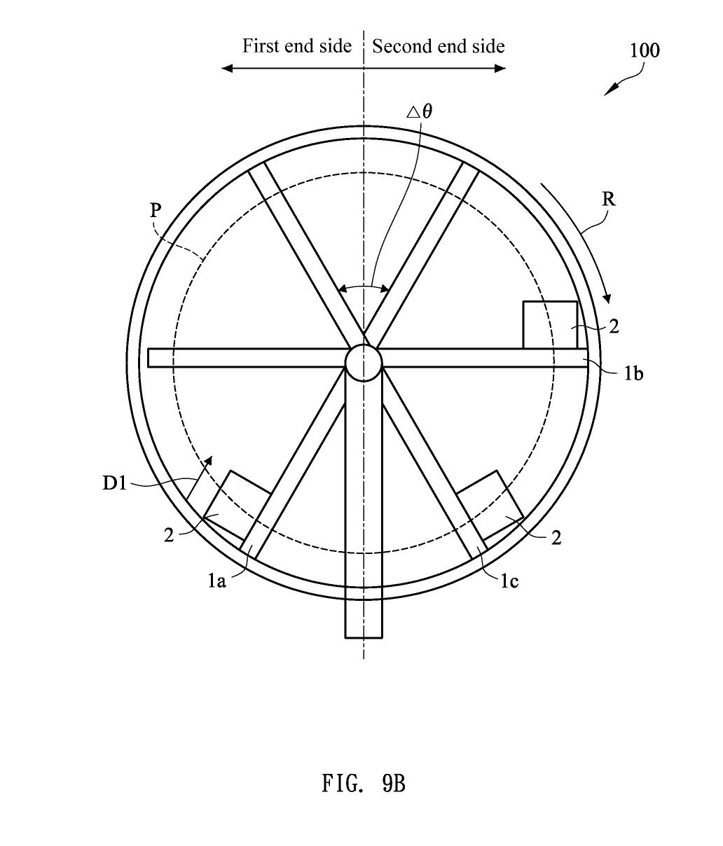

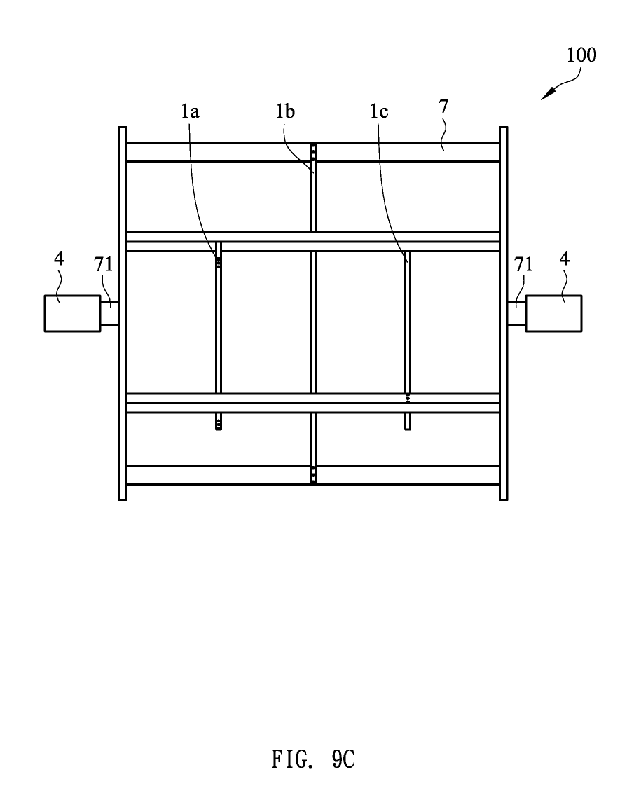

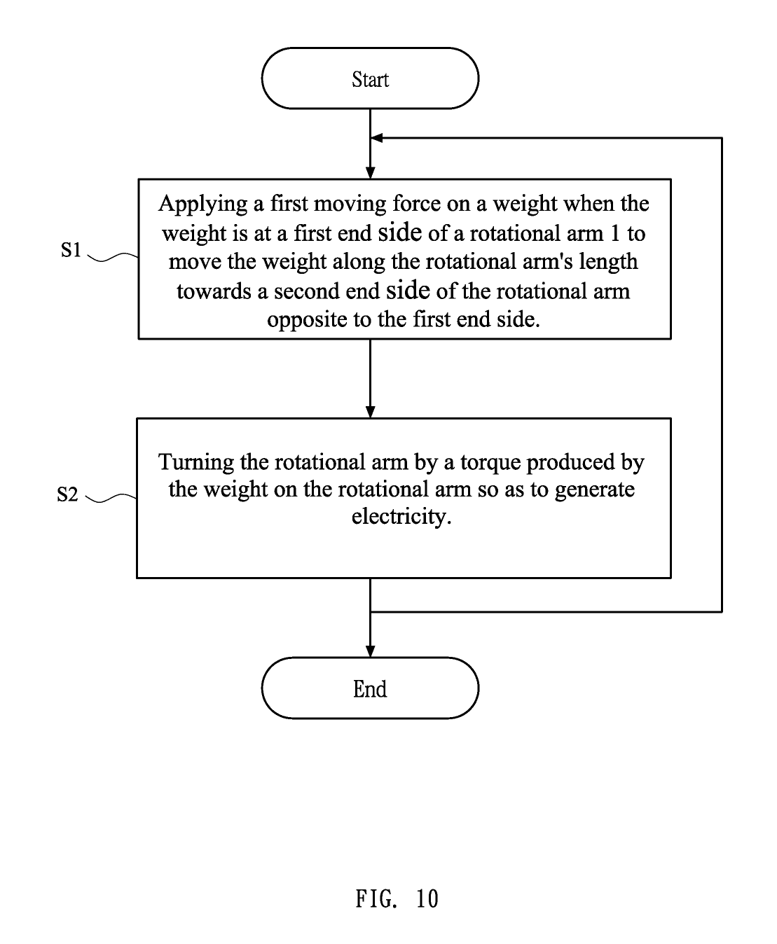

In an alternative embodiment, there can be multiple rotational arms 1, each equipped with its own weight 2 and moving mechanism 3 so as to increase the efficiency of electricity generation. As shown in FIGS. 9A to 9C, there are three rotational arms 1a, 1b, and 1c. After the weight 2 on the first rotational arm 1a is moved from the first end side to the second end side along the direction D1, the first rotational arm 1a cannot further cause the electricity generation mechanism 4 to produce electricity. However, the torque on the second and third rotational arms 1b and 1c can keep the electricity generation mechanism 4 to continue to produce electricity. The efficiency of electricity generation is as such enhanced. Preferably, the rotational arms 1a, 1b, and 1c are arranged so that each pair of them is separated by an identical angle of Δθ degrees. In addition, the rotational arms 1a, 1b, and 1c are of a same rotational inertia so as to achieve stable electricity output.

As shown in FIGS. 9A to 9C, the rotational arms 1a, 1b, and 1c are arranged diametrically on a cylindrical frame 7, and two electricity generation mechanisms 4 are coupled to the cylindrical frame 7's two axles so as to increase the efficiency of electricity generation. As shown in FIG. 9C, the rotational arms 1a, 1b, and 1c are parallel and are of a same rotational inertia so as to achieve, in addition to stable electricity output, stable rotation of the cylindrical frame 7.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. An electricity generation device comprising:
at least a rotational arm rotatably joined to an electricity generation mechanism and configured with a track element along its length;
a weight movably configured in the track element; and
a moving mechanism applying a first moving force to move the weight from a first end side of the rotational arm along the track element's length to a second end side opposite to the first end side so that a torque is produced to turn the rotational arm and electricity is generated from the electricity generation mechanism.

2. The electricity generation device according to claim 1, wherein there are a plurality of rotational arms; and each rotational arm is configured with a separate weight and a separate moving mechanism.

3. The electricity generation device according to claim 2, wherein the rotational arms are arranged so that each pair of the rotational arms is separated by an identical angle.

4. The electricity generation device according to claim 2, wherein the rotational arms are arranged diametrically and in parallel.

5. The electricity generation device according to claim 2, wherein the rotational arms are configured on a frame.

6. The electricity generation device according to claim 5, wherein the frame is cylindrical; and the electricity generation mechanism is coupled to an axle of the cylindrical frame.

7. The electricity generation device according to claim 1, wherein the moving mechanism comprises a DC motor engaging the track element so as to move the track element along the rotational arm's length.

8. The electricity generation device according to claim 7, further comprising an armature; at least an end of the rotational arm is configured with an electrical contact electrically connected to the DC motor; and the electrical contact electrically contacts the armature as the rotational arm spins and passes through the armature.

9. An electricity generation method comprising:
applying a first moving force on a weight when the weight is at a first end side of a rotational arm 1 to move the weight along the rotational arm's length towards a second end side of the rotational arm opposite to the first end side; and
turning the rotational arm by a torque produced by the weight on the rotational arm so as to generate electricity;
wherein an electricity generation mechanism is coupled to the rotational arm.

10. The electricity generation method according to claim 9, wherein the first moving force is one of an electromechanical force, an elastic restoration force, a magnetic force, and a combination of the above.
